(19) United States
(12) Patent Application Publication
(10) Pub. No.: US 2026/0277355 A1
(43) Pub. Date: Sep. 17, 2026

(54) USING SEQUENCE IDENTIFIERS TO IDENTIFY SEQUENTIAL TOUCHES IN A CAPACITIVE SENSING SYSTEM

(71) Applicant: Silicon Laboratories Inc., Austin, TX (US)

(72) Inventor: Thomas David, Lakeway, TX (US)

(21) Appl. No.: 19/077,617

(22) Filed: Mar. 12, 2025

(51) Int. Cl. G06F 3/041; G06F 1/3225; G06F 1/3234; G06F 3/044

(52) U.S. Cl. CPC G06F 3/0416; G06F 1/3225; G06F 1/3243; G06F 3/0446

(57) ABSTRACT

A technique for reducing power consumption in a sensor application while maintaining functionality that distinguishes between consecutive touches of a sensor and a continuous touch of the sensor includes configuring a processor in a low-power state of operation, assigning a sequence identifier to each traversal of the sensors for updated sensor signals, and storing sensor data including a corresponding sequence identifier in a storage element for each touch detected. The sequence identifier counter increments for each traversal of the sensors for updated sensor signals. Digital logic includes a state machine that awakens the processor from the low-power state in response to a predetermined amount of the storage element being filled. The processor moves sensor data from the storage element into a memory. The processor distinguishes between consecutive touches of the sensor and a continuous touch of the sensor based on corresponding sequence identifiers.

### BACKGROUND

### Field of the Invention

This invention relates to integrated circuit systems and more particularly to integrated circuit systems including sensor systems.

### Description of the Related Art

In general, a capacitive sensor system measures a change in capacitance of a capacitor in response to the capacitor being touched by a larger body, e.g., a human finger. A capacitive touch pad can be implemented using different technologies (e.g., using a trace on a printed circuit board or a trace on a coated surface used with an overlay, typically made of plastic or glass). If two conductive plates are spaced with a gap between them and a voltage is applied to one of the plates, then an electric field will exist between the two plates as a result of a difference between electric charges that are stored on the surfaces of the plates. A mutual capacitance configuration measures the capacitance with respect to another electrode with a potential other than ground. A self-capacitance configuration measures the absolute capacitance to ground.

In some embodiments, the capacitive touch pad is included as a capacitance to ground in a free running RC oscillator or relaxation oscillator. By keeping a resistor, drive voltage, and reaction speed of an analog comparator at constant values, a frequency produced is only dependent on the capacitance between the pad and ground. The frequency produced decreases when the capacitive touch pad is touched as compared to when the capacitive touch pad is not touched. The frequency change is measured by counting analog comparator pulses within a fixed time window and a change in count value is used as an indication of a capacitive touch pad being touched. In other embodiments, rather than using a relaxation oscillator, an analog-to-digital converter circuit generates a digital value corresponding to a voltage on a node of a switched-capacitor voltage divider circuit. Other techniques may be used to generate a digital value corresponding to a capacitance of the capacitive touch pad. A change in count value is used as an indication of a capacitive touch pad being touched. In an embodiment, a change in the measured value of capacitance relative to a baseline value is used to determine whether a touch has occurred and the absolute value is not of interest. Detecting this change is more difficult when the baseline value is larger. In some embodiments, multiple sensors are connected to the same sense line which increases the baseline value of the capacitance.

In an embodiment, a comparator circuit generates an indication of whether the digital value exceeds a predetermined detection threshold value. If the digital value does not exceed the predetermined detection threshold value, then no touch is detected. If the digital value exceeds the predetermined detection threshold value, then the digital value corresponds to a touch and the digital value is provided to a processor, which stores the digital value in memory.

An exemplary capacitive sensor system includes multiple capacitive touch pads coupled to separate pins. The capacitive sensor system traverses all pins once every sense period (e.g., 200 ms) to determine if a touch occurred in that period and a processor stores digital data associated with each traversal. For example, the processor stores in memory an identifier of a pin number and a digital value corresponding to a sensed capacitance. The processor uses the stored information to determine if a capacitive touch pad was touched. The processor also determines whether the capacitive touch pad was touched multiple distinct times or if it was touched continuously for more than one sense period. However, this technique requires the processor to remain powered up to detect touches. Accordingly, improved techniques for sensing touches of a sensor are desired.

### SUMMARY OF EMBODIMENTS OF THE INVENTION

In an embodiment, a method includes waking a processor from a low-power mode of operation in response to a predetermined amount of a storage element being filled with sensor data packets. The method includes determining whether sequential touches of a sensor are continuous or discontinuous based on the sensor data packets by the processor operating in a normal mode of operation.

In an embodiment, each of the sensor data packets includes a sensor identifier, an indication of sensed capacitance, and a corresponding sequence identifier.

In an embodiment, the method includes detecting a continuous touch of the sensor in response to the corresponding sequence identifier of a first sensor data packet for the sensor and a next corresponding sequence identifier of a next sensor data packet for the sensor being sequential values. In an embodiment, the method includes detecting separate touches of the sensor based on the corresponding sequence identifier of the first sensor data packet and the next corresponding sequence identifier of the next sensor data packet being nonsequential values.

In an embodiment, the method includes repeatedly evaluating the sensor and storing a corresponding sensor data packet in the storage element in response to corresponding sensor data indicating a corresponding touch of the sensor and discarding the corresponding sensor data in response to the corresponding sensor data indicating no touch of the sensor. In an embodiment, the method includes incrementing a counter for each evaluation of the sensor by the repeatedly evaluating. In an embodiment, the corresponding sequence identifier is based on a value of the counter coinciding with the indication of the sensed capacitance.

In an embodiment, the sensor is one of a plurality of sensors and the repeatedly evaluating includes traversing the plurality of sensors and, for each other sensor of the plurality of sensors, storing a corresponding other sensor data packet in the storage element in response to corresponding other sensor data indicating a touch of the other sensor, and discarding the corresponding other sensor data in response to the corresponding other sensor data indicating no touch of the other sensor. In an embodiment, the method includes entering the low-power mode of operation by the processor and receiving an indication of sensed capacitance from a terminal corresponding to the sensor while the processor is in the low-power mode of operation. In an embodiment, the method includes storing at least one of the sensor data packets while the processor is in the low-power mode of operation and reentering the low-power mode of operation by the processor in response to the processor reacting to the sequential touches of the sensor.

In an embodiment, an apparatus includes a processor having a low-power mode of operation and a normal mode of operation, a storage element, and digital logic configured to wake the processor from the low-power mode of operation in response to a predetermined amount of the storage element being filled with sensor data packets. The processor is configured to determine whether sequential touches of a sensor are continuous or discontinuous based on the sensor data packets.

In an embodiment, each of the sensor data packets includes a sensor identifier, an indication of sensed capacitance, and a corresponding sequence identifier. In an embodiment, the indication of sensed capacitance is a signal on a pin coupled to the sensor.

In an embodiment, the digital logic is further configured to repeatedly evaluate the sensor, store a corresponding sensor data packet in the storage element in response to corresponding sensor data indicating a corresponding touch of the sensor, and discard the corresponding sensor data in response to the corresponding sensor data indicating no touch of the sensor.

In an embodiment, the processor is configured to detect a continuous touch of the sensor in response to the corresponding sequence identifier of a first sensor data packet for the sensor and a next corresponding sequence identifier of a next sensor data packet for the sensor being sequential values, and the processor is configured to detect separate touches of the sensor corresponding to the sensor identifier in response to the corresponding sequence identifier of the first sensor data packet and the next corresponding sequence identifier of the next sensor data packet being nonsequential values.

In an embodiment, the digital logic includes a counter and the digital logic is configured to increment the counter for each traversal of a plurality of sensors, the sensor being included in the plurality of sensors. In an embodiment, the corresponding sequence identifier is based on a value of the counter coinciding with the indication of the sensed capacitance. In an embodiment, the processor is configured to reenter the low-power mode of operation after the processor reacts to the sensor data packets.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary capacitive touch pad.

FIG. 2 illustrates an exemplary two-dimensional matrix of capacitive touch pads.

FIG. 3 illustrates a signal waveform for a capacitive sensor output as a function of time for an exemplary touch event.

FIG. 4 illustrates a functional block diagram of an exemplary capacitive sensor system.

FIG. 5 illustrates an information and control flow for the exemplary capacitive sensor system of FIG. 4.

The use of the same reference symbols in different drawings indicates similar or identical items.

### DETAILED DESCRIPTION

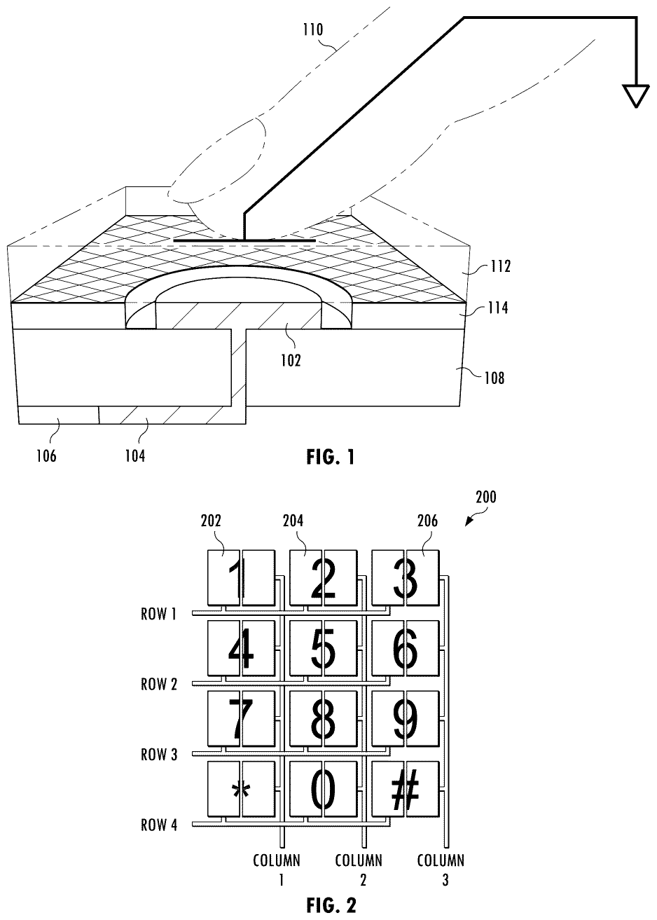

In an embodiment, a capacitive touch pad of a capacitive sensing system generates an electrostatic field along a conductive interface that corresponds to capacitance C_{EXT}=C_{PAD} (e.g., C_{PAD} is in a range of 5 pF-40 pF). Referring to FIG. 1, in an exemplary capacitive touch pad that uses self-capacitance, printed circuit board 108 includes overlay 112 on sensor pad 102 and ground plane 114 (e.g., ground hatch). Digit 110 causes a change in the electrostatic field of a dielectric material between conductive plates in response to digit 110 touching overlay 112. The system capacitance increases to C_{EXT}=C_{PAD}+C_{T} (where C_{T} is in a range of 200 fF-20 pF). An exemplary capacitive touch pad has sensitivity ΔC_{EXT} of approximately 0.5%-50%. A change in capacitance in response to a touch causes a change in voltage on trace 104, which provides the voltage to pin 106. In some embodiments, a capacitive touch pad is a stand-alone capacitive touch pad. In other embodiments, a capacitive touch pad is one of a plurality of capacitive touch pads that use mutual capacitance, which are configured in an array of pads that are identifiable by a row and a column, as illustrated in FIG. 2. For example, capacitive touch pads 202, 204, and 206 are coupled to a conductor corresponding to row 1 of pad array 200 and are coupled to conductors corresponding to column 1, column 2, and column 3, respectively.

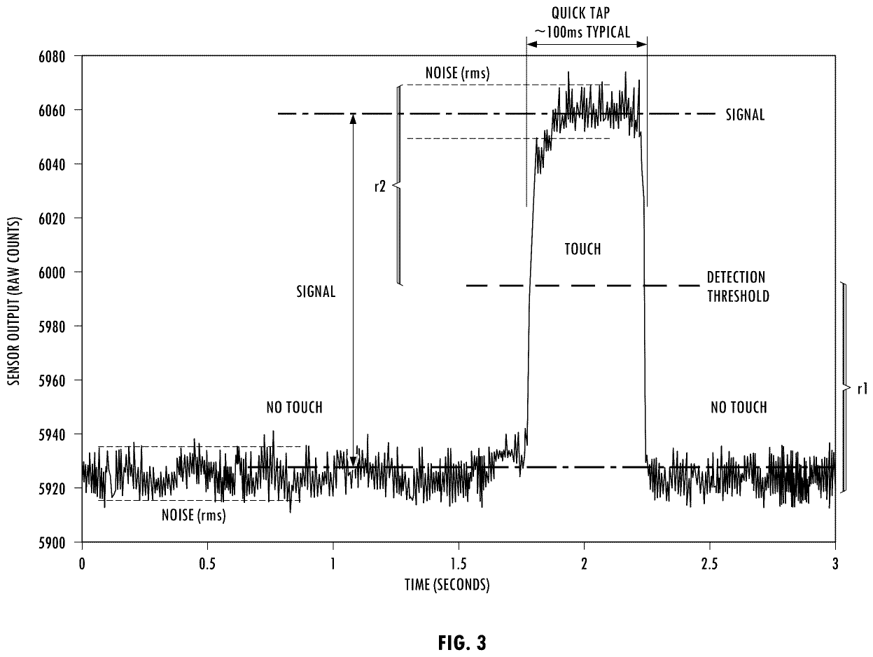

Referring to FIGS. 1-3, each capacitive touch pad provides a value in a first range (i.e., a baseline range, e.g., range r1) if the capacitive touch pad is not being touched and provides a second value in a second range (e.g., range r2) if the pad is being touched. For example, a capacitive touch pad has a baseline event that provides a digital code output in the range of approximately 5925. A typical touch event is a quick tap of approximately 100 ms that generates a digital code of approximately 6058. An exemplary detection threshold of approximately 5995 would cause the sensor system to detect the quick tap and generate an indication of the touch event.

The capacitive sensor system distinguishes between a capacitive touch pad being quickly tapped more than once and the capacitive touch pad being tapped once and continuously held down for a period of time. For example, the capacitive sensor system distinguishes between a user quickly tapping “22” and a user continuously pressing “2” for at least a predetermined interval (i.e., an interval exceeding a user input response period, human response time, or touch time). As discussed above, in a conventional capacitive sensing application, distinguishing between consecutive touches and a continuous touch is handled by software executing on a processor. The processor executes a scan algorithm that traverses all inputs (e.g., signals on distinct pins of an integrated circuit), which are coupled to capacitive touch pads of an array of touch pads, and provides a digital value based on a voltage on a pin for each of the capacitive touch pads. The software determines how much time elapsed between consecutive detections of the “2” based on predetermined timing of the scan algorithm. The software determines whether the capacitive touch pad was quickly tapped multiple times or if it was pressed continuously based on the elapsed time. This technique requires that a processor constantly operate in a regular operating mode. Software executing on the processor executes a scan command and captures data accordingly. The software uses the frequency and number of scan commands issued to identify whether a pad was quickly tapped multiple times sequentially or touched fewer times with at least one continuous touch.

A technique for reducing power consumption in a sensor application while maintaining functionality that distinguishes between consecutive touches of a sensor and a continuous touch of the sensor includes configuring a processor in a low-power state of operation, assigning a sequence identifier to each traversal of the sensors for updated sensor signals, and storing sensor data including a corresponding sequence identifier in a storage element for each touch detected. The sequence identifier counter increments for each traversal of the sensors for updated sensor signals. Digital logic includes a state machine that awakens the processor from the low-power state in response to a predetermined amount of the storage element being filled. The processor moves sensor data from the storage element into a memory. The processor distinguishes between consecutive touches of the sensor and a continuous touch of the sensor based on corresponding sequence identifiers. The processor resets a pointer to the storage element, responds to the touches of the sensor, and returns to the low-power state to conserve power.

In an embodiment of a sensor interface, an analog interface is coupled to external sensors and receives a sensed signal (e.g., a voltage) and compares an indication of the sensed signal to a predetermined threshold value. If the indication of the sensed signal exceeds the predetermined threshold value, then the analog interface generates an indication of a touch for that sensor and provides a digital value corresponding to the sensed signal to digital logic 408. In response to receiving the indication of the touch for the sensor, the digital logic stores a digital value, a sensor identifier, and a current value of a sequence identifier counter as a data packet in a storage element. If no touch is detected, then the digital value is discarded, digital logic does not save a data packet in the storage element, and the digital logic increments the sequence identifier counter. In response to a predetermined amount of the storage element being filled, digital logic generates an indication thereof. If the processor is in a low-power state, the indication causes the processor to wake-up and to copy or move the data from the storage element into a memory coupled to the processor. The processor resets a pointer to the storage element and then evaluates each data packet (e.g., digital value, a sensor identifier, and the sequence identifier counter value) in the memory to determine whether a sensor was pressed continuously or if the sensor was quickly tapped repeatedly. If there is a gap between the values of the sequence identifiers of consecutive data packets for a sensor, then the sensor was quickly tapped repeatedly (e.g., a push is detected, then not detected, then detected again in consecutive traversals of the sensors). If there is no gap between the values of the sequence identifiers of consecutive data packets for the sensor, then the sensor was pressed continuously across consecutive traversals of the sensor.

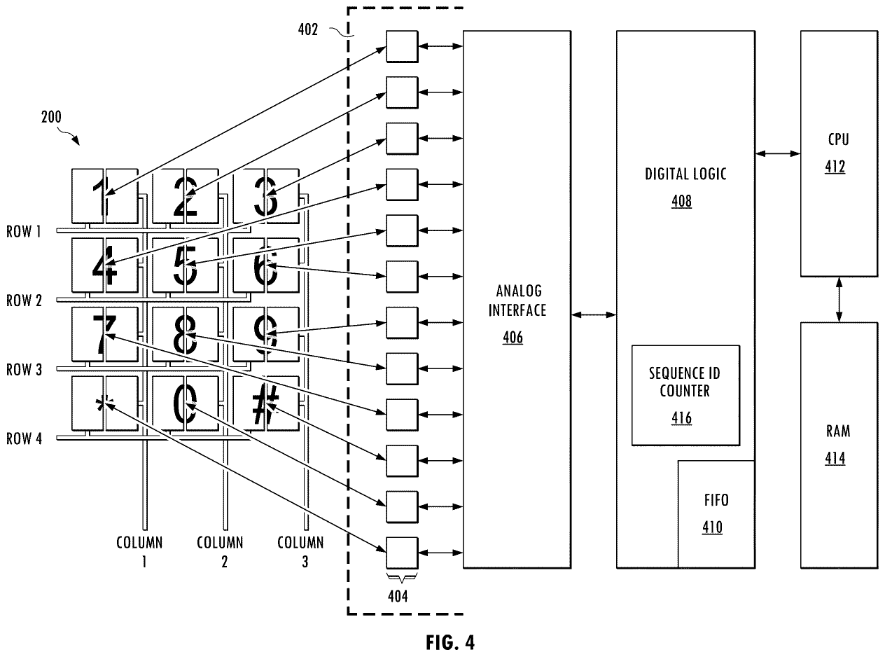

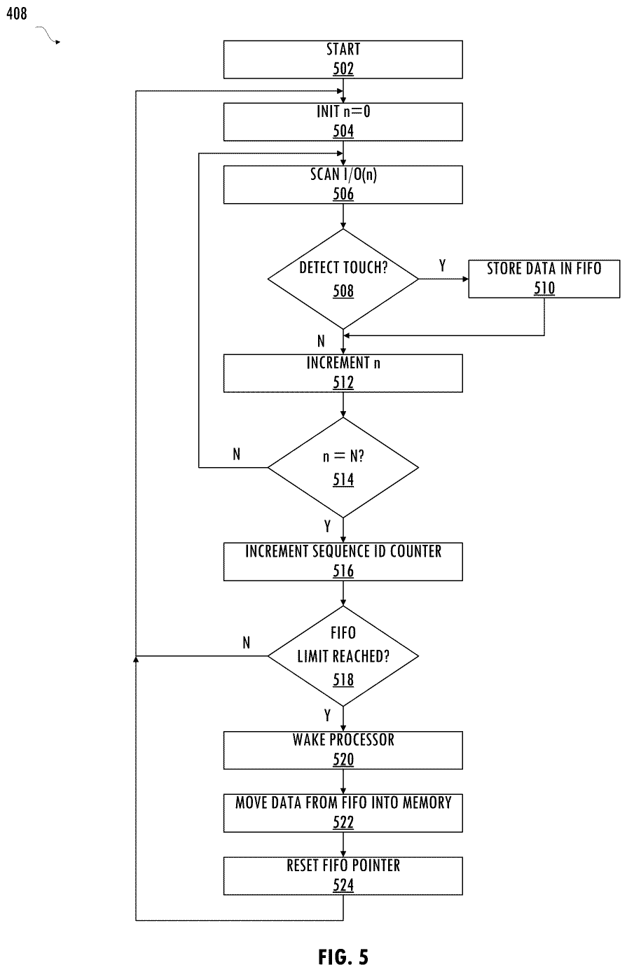

Referring to FIGS. 4 and 5, in an embodiment of a capacitive sensor system, capacitive touch pads are arranged in a grid of rows and columns as array of capacitive touch pads 200. Each of the capacitive touch pads is coupled to an input/output (I/O) terminal of an integrated circuit product, e.g., bond pads 404 of integrated circuit product 402. In an embodiment of integrated circuit product 402, analog interface 406 senses mutual capacitance with respect to another electrode with a potential other than ground. In another embodiment of integrated circuit product 402, analog interface 406 senses self-capacitance of an absolute capacitance to ground. Analog interface 406 receives a voltage on each of bond pads 404 and compares each of those voltages to a predetermined threshold value. If the voltage exceeds the predetermined threshold value, then analog interface 406 provides an indication of a touch of a corresponding capacitive touch pad and digital logic 408 stores a digital code corresponding to the voltage level. The digital code may be generated by analog interface 406 or digital logic 408 using conventional analog-to-digital conversion techniques and has a value or range of values that may vary with the type of digital filtering applied to the signal.

Digital logic 408 includes a state machine implementing a capacitive sensing process that increments a counter each time the digital codes are updated based on a signal received from bond pads 404. In at least one embodiment, digital logic 408 starts the capacitive sensing process (502) by initializing sensor counter n (e.g., n=0) for a capacitive sensor interface having N capacitive touch pads coupled to N I/O. Analog interface 406 scans I/O n and compares the voltages on the I/O to a predetermined voltage level (506). For each I/O having a voltage level that exceeds the predetermined voltage level, analog interface 406 generates indication of a touch (508). In response to each indication of a touch, digital logic 408 stores a data packet (e.g., a digital code indicative of a voltage level on the corresponding I/O, the value of n, a row identifier and a column identifier of an array, or other identifier of the I/O, and a value of sensor identifier counter 416) in First-In-First-Out (FIFO) 410 (510). Digital logic 408 increments a pointer that identifies a next location of FIFO 410 in which to store a next data packet (512). If an I/O has a voltage level that does not exceed the predetermined voltage level, then analog interface 406 does not set an indication of a touch and the voltage is discarded (i.e., not saved in FIFO 410 by digital control 408). In other embodiments, other storage elements and data packets are used.

After saving a data packet and incrementing the pointer for an indication of any touch, digital logic 408 increments n (514) and repeats I/O scan and touch detection until all N capacitive touch pads have been traversed. If all N capacitive touch pads have been traversed (e.g., n=N), then digital logic 408 increments sequence identifier counter 416 (516). In an exemplary embodiment, the sequence identifier counter is eleven bits wide, and the sequence identifier counter rolls over after value 2048 with a frequency of 2 MHz. The sensors are traversed once per predetermined interval (e.g., 200 ms) and a digital value corresponding to a sensed quantity (e.g., voltage) is received by analog interface 406 for each of the sensors.

If the pointer value indicates that FIFO 410 is filled by at least a predetermined amount (518), then digital logic 408 generates a signal to wake CPU 412 (520). In response to the signal, CPU 412 transitions from the low-power mode of operation to a normal mode of operation and executes software that copies or moves the contents of FIFO 410 into Random Access Memory (RAM) 414 (522), resets the FIFO pointer (524), and digital logic 408 resumes traversing the I/O. If the FIFO limit has not been reached (e.g., a pointer to FIFO 410 does not indicate that FIFO 410 is filled by at least the predetermined amount) (518), then digital logic 408 continues to traverse the I/O while CPU 412 remains in the low-power mode of operation. The information and control flow of FIG. 4 is exemplary only and other sequences of operations can be used to collect data packets while CPU 412 is in a low-power state and to wake CPU 412 to process the data packets to distinguish between sequential and continuous touches of capacitive sensors after being awakened from the low-power state. Software (which may include firmware), as described herein, may be encoded in at least one tangible (i.e., non-transitory) computer readable medium. As referred to herein, a tangible computer-readable medium includes at least a disk, tape, or other magnetic, optical, or electronic storage medium.

In at least one embodiment, the software executing on CPU 412 reacts to the data stored in RAM 414. In an embodiment, the software provides access to a system in response to detecting that a sequence of touches corresponds to a predetermined code stored in non-volatile memory. In an embodiment, the software causes CPU 412 to enter the low-power mode of operation in response to a sequence of touches not being equivalent to a predetermined sequence of touches. For example, CPU 412 detects a touch of capacitive touch pad having an identifier equal to ‘2’ coincident with sequence identifier counter 416 being equal to ‘1.’ Digital logic 408 stores in FIFO 410 a data packet including ‘2,’ ‘1,’ and in some embodiments, a digital code corresponding to the capacitance value. Digital logic 408 increments sequence identifier counter 416 to ‘2’ after all capacitive touch pads have been traversed. A next traversal of the capacitive touch pads occurs 200 ms after the start of the prior traversal of the capacitive touch pads. CPU 412 does not detect a touch for any pad while sequence identifier counter 416 equals ‘2’ and digital logic 408 increments sequence identifier counter 416 to ‘3.’ A next traversal of the capacitive touch pads occurs 200 ms after the start of the prior traversal of the capacitive touch pads. CPU 412 does not detect a touch for any pad while sequence identifier counter 416 equals ‘3’ and digital logic 408 increments sequence identifier counter 416 to ‘4.’ The pad having an identifier equal to ‘2’ is detected as being touched coincident with sequence identifier counter 416 being equal to ‘4.’ Digital logic 408 stores in FIFO 410 a data packet including ‘2,’ ‘4,’ and a digital code for the corresponding capacitance value. Digital logic 408 increments sequence identifier counter 416 to ‘5’ after all capacitive touch pads have been traversed. The pad having an identifier equal to ‘2’ is detected as being touched coincident with sequence identifier counter 416 being equal to ‘5.’ Digital logic 408 stores in FIFO 410 a data packet including ‘2,’ ‘5,’ and a digital code for the corresponding capacitance value. Digital logic 408 increments sequence identifier counter 416 to ‘5’ after all capacitive touch pads have been traversed.

Additional traversals and additional touches are detected on other pads and FIFO 410 fills with data packets causing digital logic 408 to wake CPU 412. In response, CPU 412 loads the data from FIFO 410 to RAM 414 and resets the FIFO pointer so digital logic 408 can continue to detect touches. Meanwhile, CPU 412 uses the data packets stored in RAM 414 to determine that a gap occurs between the touches of sequence identifier ‘2’ and sequence identifier ‘4.’ Thus, CPU 412 detects that capacitive touch pad ‘2’ had two separate touches at sequence identifier ‘2’ and sequence identifier ‘4.’ CPU 412 further uses the data stored in RAM 414 to determine that no gap occurs between the touches of sequence identifier ‘4’ and sequence identifier ‘5.’ Thus, CPU 412 detects that capacitive touch pad ‘2’ was continuously touched starting at sequence identifier ‘4’ and continuing through sequence identifier ‘5.’ By capturing data while CPU 412 is in a low power mode of operation, the technique reduces reliance on software and reduces power consumption of the capacitive sensor system.

Thus, techniques that increase time for a processor to operate in a low-power mode to reduce power consumption in a capacitive sensing system have been described. The description of the invention set forth herein is illustrative and is not intended to limit the scope of the invention as set forth in the following claims. For example, while the invention has been described in an embodiment in which capacitive touch sensing is used, one of skill in the art will appreciate that the teachings herein can be utilized with resistive touch sensing, infrared touch sensing, optical touch sensing, surface acoustic wave, or other touch sensing techniques. The terms “first,” “second,” “third,” and so forth, as used in the claims, unless otherwise clear by context, are to distinguish between different items in the claims and do not otherwise indicate or imply any order in time, location or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

1. A method comprising:
waking a processor from a low-power mode of operation in response to a predetermined amount of a storage element being filled with sensor data packets, each of the sensor data packets including a corresponding sequence identifier; and
determining whether sequential touches of a sensor are continuous or discontinuous based on the sensor data packets by the processor operating in a normal mode of operation,
detecting a continuous touch of the sensor in response to the corresponding sequence identifier of a first sensor data packet for the sensor and a next corresponding sequence identifier of a next sensor data packet for the sensor being sequential values; and
detecting separate touches of the sensor based on the corresponding sequence identifier of the first sensor data packet and the next corresponding sequence identifier of the next sensor data packet being nonsequential values.

2. The method as recited in claim 1 wherein each of the sensor data packets further includes a sensor identifier and an indication of sensed capacitance.

3. (canceled)

4. A method comprising:
waking a processor from a low-power mode of operation in response to a predetermined amount of a storage element being filled with sensor data packets; and
determining whether sequential touches of a sensor are continuous or discontinuous based on the sensor data packets by the processor operating in a normal mode of operation,
repeatedly evaluating the sensor and storing a corresponding sensor data packet in the storage element in response to corresponding sensor data indicating a corresponding touch of the sensor and discarding the corresponding sensor data in response to the corresponding sensor data indicating no touch of the sensor; and
incrementing a counter for each evaluation of the sensor by the repeatedly evaluating,
wherein each of the sensor data packets includes an indication of sensed capacitance and a corresponding sequence identifier, and
wherein the corresponding sequence identifier is based on a value of the counter coinciding with the indication of the sensed capacitance.

5. The method as recited in claim 4 wherein the sensor is one of a plurality of sensors and the repeatedly evaluating comprises:
traversing the plurality of sensors and for each other sensor of the plurality of sensors, storing a corresponding other sensor data packet in the storage element in response to corresponding other sensor data indicating a touch of the other sensor and discarding the corresponding other sensor data in response to the corresponding other sensor data indicating no touch of the other sensor.

6. The method as recited in claim 4
wherein the repeatedly evaluating repeats evaluation at periodic intervals having a predetermined period,
wherein the predetermined period is less than an input response period.

7. The method as recited in claim 4
wherein the indication of sensed capacitance is a signal on a pin coupled to the sensor, and
wherein the repeatedly evaluating includes determining whether the signal exceeds a predetermined value.

8. The method as recited in claim 1 further comprising:
in response to waking the processor, storing contents of the storage element in a memory and resetting a pointer to the storage element.

9. The method as recited in claim 1 further comprising:
entering the low-power mode of operation by the processor;
receiving an indication of sensed capacitance from a terminal corresponding to the sensor while the processor is in the low-power mode of operation;
storing at least one of the sensor data packets while the processor is in the low-power mode of operation; and
reentering the low-power mode of operation by the processor in response to the processor reacting to the sequential touches of the sensor.

10. An apparatus comprising:
a processor having a low-power mode of operation and a normal mode of operation;
a storage element; and
digital logic configured to wake the processor from the low-power mode of operation in response to a predetermined amount of the storage element being filled with sensor data packets,
wherein the processor is configured to determine whether sequential touches of a sensor are continuous or discontinuous based on the sensor data packets, and
wherein the digital logic is further configured to repeatedly evaluate the sensor, store a corresponding sensor data packet in the storage element in response to corresponding sensor data indicating a corresponding touch of the sensor, and discard the corresponding sensor data packet in response to the corresponding sensor data indicating no touch of the sensor.

11. The apparatus as recited in claim 10,
wherein each of the sensor data packets includes a sensor identifier, an indication of sensed capacitance, and a corresponding sequence identifier.

12. The apparatus as recited in claim 11 wherein the indication of sensed capacitance is a signal on a pin coupled to the sensor.

13. (canceled)

14. The apparatus as recited in claim 11, wherein the processor is configured to detect a continuous touch of the sensor in response to the corresponding sequence identifier of a first sensor data packet for the sensor and a next corresponding sequence identifier of a next sensor data packet for the sensor being sequential values, and the processor is configured to detect separate touches of the sensor corresponding to the sensor identifier in response to the corresponding sequence identifier of the first sensor data packet and the next corresponding sequence identifier of the next sensor data packet being nonsequential values.

15. The apparatus as recited in claim 11, wherein the digital logic comprises:
a counter,
wherein the digital logic is configured to increment the counter for each traversal of a plurality of sensors, the sensor being included in the plurality of sensors, and
wherein the corresponding sequence identifier is based on a value of the counter coinciding with the indication of the sensed capacitance.

16. The apparatus as recited in claim 10,
wherein the digital logic repeats evaluation at periodic intervals having a predetermined period,
wherein the predetermined period is less than an input response period.

17. The apparatus as recited in claim 10 wherein the processor is further configured to store contents of the storage element in a memory and reset a pointer to the storage element in response to the processor being woken from the low-power mode of operation.

18. The apparatus as recited in claim 10 wherein the processor is configured to reenter the low-power mode of operation after the processor reacts to the sensor data packets.

19. The apparatus as recited in claim 10 further comprising:
an analog interface coupled to the digital logic; and
a plurality of capacitive sensors coupled to the analog interface, the sensor being included in the plurality of capacitive sensors.

20. (canceled)

21. The method as recited in claim 2 further comprising:
repeatedly evaluating the sensor and storing a corresponding sensor data packet in the storage element in response to corresponding sensor data indicating a corresponding touch of the sensor and discarding the corresponding sensor data in response to the corresponding sensor data indicating no touch of the sensor; and incrementing a counter for each evaluation of the sensor by the repeatedly evaluating,
wherein the corresponding sequence identifier is based on a value of the counter coinciding with the indication of the sensed capacitance.

22. The method as recited in claim 21 wherein the sensor is one of a plurality of sensors and the repeatedly evaluating comprises:
traversing the plurality of sensors and for each other sensor of the plurality of sensors, storing a corresponding other sensor data packet in the storage element in response to corresponding other sensor data indicating a touch of the other sensor and discarding the corresponding other sensor data in response to the corresponding other sensor data indicating no touch of the other sensor.

23. The method as recited in claim 4 further comprising:
in response to waking the processor, storing contents of the storage element in a memory and resetting a pointer to the storage element;
entering the low-power mode of operation by the processor;
receiving the indication of sensed capacitance from a terminal corresponding to the sensor while the processor is in the low-power mode of operation; and
reentering the low-power mode of operation by the processor in response to the processor reacting to the sequential touches of the sensor.
